(19) United States
(12) Patent Application Publication
(10) Pub. No.: US 2013/0295260 A1
(43) Pub. Date: Nov. 7, 2013

(54) Liquid Aroma and Flavouring Compositions

(71) Applicant: SYMRISE AG, Holzminden (DE)

(72) Inventors: Dirk Schrader, Holzminden (DE); Christopher Sabater-Luenzel, Holzminden (DE); Thomas Henze, Holzminden (DE); Martina Batalia, Boffzen (DE); Sebastian Heine, Hoxter (DE)

(73) Assignee: Symrise AG, Holzminden (DE)

(21) Appl. No.: 13/867,361

(22) Filed: Apr. 22, 2013

(30) Foreign Application Priority Data
May 1, 2012 (EP) 12 166276

(51) Int. Cl. A23L 1/22

(52) U.S. Cl. CPC A23L 1/22058
USPC 426/534; 426/650; 426/651; 426/557; 426/549; 426/560; 426/559

(57) ABSTRACT

Suggested are liquid flavour substance mixtures, comprising

(a) 10 to 25% by weight oil-soluble aroma emulsions or aroma concentrates,

(b) 15 to 25% by weight inorganic salts,

(c) 6 to 12% by weight water-soluble constituents,

(d) 2 to 10% by weight water-insoluble constituents and dyes,

(e) 0.1 to 6% by weight hydrocolloids and emulsifiers and

(f) ad 100% by weight water,

with the proviso that the aroma emulsions forming component (a), which, in turn, comprise

(a1) 0.1 to 40% by weight oil-soluble aromatic compounds,

(a2) 5 to 20% by weight stabilizers,

(a3) 0 to 1% by weight preservatives and

(a4) ad 100% by weight water.

### AREA OF THE INVENTION

The invention relates to the area of aromas and flavourings and further relates to liquid aroma and flavouring compositions, a process of their production, foods using these compositions and the use of these compositions for the loading of foods.

### STATE OF THE ART

A wide range of industrially produced foods such as, for example, chips, extrudates, cereals or extruded products, which mostly include pasta, are seasoned by sprinkling seasoning mixtures on them which are referred to as “dust-ons”. Said dust-ons contain, besides diverse seasoning powders, also high amounts of cooking salt as well as herbs and flavouring extracts. Averaging 6% by weight, also the dosage of these dust-on seasonings is comparably high. Therefore, just for economic reasons, there is a need for more simple methods for seasoning said product groups obtaining the same sensory effect but using a smaller amount of seasoning. This particularly concerns the desired saltiness of the products, as the high amount of NaCl added does not only entail higher costs for raw material, transport and storage, but is critical with respect to raised blood pressure. In this context it is also unpleasant that a considerable amount of dust-on seasoning tends to stick to the fingers when consumed, as consumers usually do not use cutlery but their fingers, which is often perceived as an unpleasant effect. Also for this problem a “clean fingers” solution will be sought. Eventually, another problem is that the top note, meaning the amount in volatile aroma carriers of the applied aroma and flavouring systems, will need to be improved such that particularly the released aroma is intensified when consumers open the food package.

From the Japanese patent application JP 2009 189314 A1 (House Food Corp.) seasoning mixtures are known in this context, which are directly mixed with the foods to be produced, comprising a hydrophilic emulsifier having an HLB value of from 8 to 18 and a lipophilic emulsifier having an HLB value in the range of from 3 to 7. The mixtures are O/W emulsions and contain 20 to 40% by weight fat constituents and 45 to 80% by weight water.

The subject matter of the Japanese patent application JP 2006 246885 A1 are emulsions, comprising proteins and glucides in the aqueous phase and dissolved aroma substances in the oil phase.

Lastly, the Japanese patent application JP 9 322735 A2 (Ichibiki) discloses fluid seasoning compositions, for the production of which animal fats are stably emulsified in an aqueous solution of aroma and flavouring substances and salts.

However, none of the seasoning compositions disclosed in the state of the art is capable of solving the problems described above.

Therefore, the complex objective of the invention was to provide a solution for a bundle of sub-objectives, which are:
An improved method of application of the seasoning compositions, particularly as an alternative to the dust-on method hitherto used;
An intensification of the sensory perception of the aromas and flavourings at a reduced dosage of the aromas and flavourings;
An unvarying sensory effect of saltiness at a reduced dosage of inorganic salts;
An intensification of the top note when consumers are opening the packages;
A way to keep one's fingers clean, which means a reduction in stickiness of the seasoning mixtures when the products are consumed with one's fingers.

### DESCRIPTION OF THE INVENTION

The subject matter of the invention is liquid aroma and flavouring compositions, comprising

(a) 15 to 20% by weight oil-soluble aroma emulsions or aroma concentrates,

(b) 15 to 25% by weight inorganic salts,

(c) 6 to 12% by weight water-soluble constituents,

(d) 2 to 10% by weight water-insoluble constituents and dyes,

(e) 0.1 to 6% by weight hydrocolloids and emulsifiers and

(f) ad 100% by weight water,

with the proviso that the aroma emulsions forming component (a), in turn, comprise

(a1) 0.1 to 40% by weight oil-soluble aromatic compounds,

(a2) 5 to 20% by weight stabilizers,

(a3) 0 to 1% by weight preservatives and

(a4) ad 100% by weight water.

The expression “ad 100% by weight water” used herein means that the balance of the composition so as to reach 100% is water.

Surprisingly it was found that the liquid aroma and flavouring compositions—which, preferably, are emulsions—constitute an alternative to the classic dust-on seasoning of snacks such as chips, biscuits, cereals, but also pasta. The mixtures are storage-stable over a long period of time and are easily sprayable also when present in higher viscosities of up to 6.000 mPas. During sampling it was found that they allow a lower dosage of salts and flavours while providing the same sensory effect, which would lead to a reduction in raw material costs and is also connected to health advantages. In particular, foods which are loaded with the mixtures according to the invention are characterized—in comparison with conventional products—by the fact that a stronger olfactory impression and a higher saltiness are perceived given the same amounts of aroma and flavouring substances and salts. In addition, the seasoning mixtures stuck less to the fingers. A further unexpected effect in context with potato chips is that, despite of the water content remaining on top of or within the foods when the liquid compositions are applied, there is no loss in crunchiness. This means that the typical crunching sound (“crunch”) desired by the consumer is not lost during consumption.

Aroma Concentrates

The compositions according to the invention are composed of aroma concentrates—which are, to some extent, a pre-mixture—and of the liquid end products. The aroma concentrates are produced using oil-soluble aromatic compounds and are emulsified by adding suitable stabilizers, preferably polysaccharides, or they are used as an oil-soluble concentrate in small amounts. The concentrates typically contain from about 50 to about 80, preferably, from about 60 to about 75, and more particularly from about 62 to about 73% by weight water.

a1) Oil-Soluble Aromatic Compounds

Oil-soluble aromatic compounds contained as component (a1) in the aroma concentrates may, for example, be selected from the group consisting of essential oils. These are understood to be secondary plant ingredients, which are usually obtained by (water steam) extraction from the most diverse plants and plant parts. They are predominantly aromatic compounds or terpenes, specifically mono- or sesquiterpenes.

Typical examples of aromatic compounds are the phenols carveol, carvacrol, thymol, the phenylpropanoids apiol, cinnamic aldehydes, anethole, dillapiole and estragole, or the furanocoumarin coriandrin. Acyclic terpenes include ocimene, myrcene, linalool, geraniol, nerol, citronellal, geranyl acetate, linalyl acetate, farnesol and farnesene. Examples of monocyclic and bicyclic terpenes are limonene, terpinene, phellandrene, carvone, menthone, menthol, menthofuran, cineol, anethofuran, bisabolol, caryophyllene, pinene, camphene, sabinol, borneol, camphor, fenchone, chamazulene and caryophyllene. Said essential oils possess the most diverse aromatic and flavour notes, ranging from citrus (for example, lirnonene) to peppermint (for example, menthone), from fennel (for example, fenchone) to coriander (for example, coriandrin) and dill (for example, dillapiole) and are notoriously known to the person skilled in the art. Thus no inventiveness is required to identify and use the suitable corresponding oil-soluble aromatic compounds in general and the essential oils in particular for any given flavour. Therefore, the above list is understood to be exemplary and not restrictive.

The aromatic compounds can be present in the concentrates in amounts from about 0.1 to about 40 and, preferably, from about 1 to about 25, and more particularly, from about 10 to about 25% by weight.

a2) Stabilizers

The stabilizers forming component (a2) of the aroma concentrates are emulsifiers known to one skilled in the art but are, preferably, polysaccharides. Suitable examples thereof are gum arabic, pectine, xanthan gum, quillaja extracts, fatty acid esters, sugar esters, sorbitan esters, modified starch and the mixtures thereof. The stabilizers may be present in the concentrates in amounts of from about 5 to about 20, and more particularly, from about 12 to about 18% by weight.

a3) Preservatives

The aroma concentrates may optionally contain—specifically when the products are not finally pasteurised—preservatives (component a3) in amounts of from about 0.1 to about 1 and, preferably, of from about 0.2 to about 0.8% by weight, provided these are approved for use in foods. Typical examples thereof are citric acid, tartaric acid or ascorbic acid and the alkaline earth salts thereof.

Liquid Aroma and Flavouring Compositions

The pre-emulsions or aroma concentrates produced in a first step are subsequently incorporated in a base material, which is stabilized with a suitable hydrocolloid and which contains—besides water-soluble extracts—also inorganic salts, specifically, of course, sodium chloride. The portion of aroma concentrates in the liquid end compositions is typically present in amounts of from about 10 to about 25, and, preferably, from about 12 to about 20% by weight. The final compositions have a total water content of from about 40 to about 75, preferably, from about 45 to about 70 and more particularly from about 50 to about 65% by weight. The liquid end products remain stable, fluid and pumpable over a period of several weeks and can, therefore, be easily applied to foods.

b) Inorganic Salts

The liquid aroma concentrates predominantly contain, besides the aroma concentrates (component a), inorganic salts (component b), which are selected from the group consisting of sodium chloride and potassium chloride and the mixtures thereof. The salts may be present in amounts of from about 15 to about 25, preferably, from about 17 to about 22% by weight.

c) Water-Soluble Constituents

The liquid compositions may further comprise as component (c) water-soluble constituents, which are selected from the group consisting of plant extracts and herb extracts, sweeteners and flavour enhancers.

Suitable plant species and herb species are, for example: European speedwell, bittercress, wild garlic, spignel, basil, mugwort, burnet, savory, borage, common watercress, the leaves of the curry tree, curry plant, dill, tarragon, fennel, garden cress, shepherd's purse, Southern Cone marigold (Huacatay), nasturtium, chervil, coriander leaves, caraway, lavender, lovage, laurel (Bay laurel), dandelion, marjoram, meadowsweet, mints, myrtle, echium (Viper's bugloss), oregano, parsley, peppermint, salad burnet, arugula, rosemary, sage, sorrel, celery, garlic chives, chives, deadnettle, thyme, woodruff, common rue, cow parsley, Japanese bunching onion, hyssop, lemon grass, lemon balm and lemon verbena. Extracts of vegetables such as, for example, paprika powder or garlic powder; cheese powder or yeast extracts are also suitable.

The plant extracts and herb extracts may be prepared by known methods of extracting plants or parts thereof, or leaves or fruit, for example, by aqueous, alcoholic or hydroalcoholic extraction. All conventional extraction processes are suitable such as, for example, maceration, re-maceration, digestion, agitation maceration, vortex extraction, ultrasonic extraction, countercurrent extraction, percolation, re-percolation, evacolation (extraction under reduced pressure), diacolation or continuous solid/liquid extraction. The percolation method is advantageous for industrial use. Fresh plants or parts of plants can be used as starting material, however, dried plants and/or parts of dried plants, which can be mechanically reduced in size before extraction, are usually applied. In doing so, all known methods for mechanical size-reduction known to the person skilled in the art are suitable. An example therefor is cryogrinding. Suitable solvents for carrying out the extraction process may be organic solvents, water (preferably hot water having a temperature of above 80° C. and more particularly, of above 95° C.) or mixtures of organic solvents and water, particularly low-molecular alcohols having a more or less high water contents. Particularly preferred is the extraction process using methanol, ethanol, pentane, hexane, heptane, acetone, propylene glycols, polyethylene glycols and ethyl acetate and mixtures thereof and aqueous mixtures thereof. The extraction process is usually carried out at temperatures of from 20 to 100° C., preferably, of from 30 to 90° C., more particularly of from 60 to 80° C. In a preferred embodiment, the extraction process is carried out in an inert gas atmosphere to avoid oxidation of the active principles of the extract. This is particularly significant for extraction processes carried out at temperatures of above 40° C. The person skilled in the art will adjust extraction times depending on the starting material, extraction process, extraction temperature, solvent—raw material ratio, etc. After the extraction process, the obtained raw extracts may optionally be subjected to other conventional steps such as, for example, purification, concentration and/or decoloration. If desired, the extracts thus prepared may, for example, be subjected to a selective removal of individual unwanted ingredients. The extraction process can be carried out to any degree, but is usually continued to exhaustion. Typical yields (=ratio of amount of dry matter of the extract based on the quantity of raw material used) of the extraction process of dried leaves are in the range from 3 to 15, particularly, from 6 to 10% by weight. The extracts may also serve as starting material to obtain the pure active principles mentioned above, provided that they cannot be produced synthetically more simply and at a lower cost. Therefore, the content of active principles in the extracts may amount from 5 to 100, preferably, from 50 to 95% by weight. The extracts themselves may be present as aqueous solutions and/or compositions dissolved in organic solvents and as spray-dried or freeze-dried water-free solid substances. Suitable organic solvents in this context are, for example, the aliphatic alcohols having from 1 to 6 carbon atoms (for example, ethanol), ketones (for example, acetone), halogenated hydrocarbons (for example, chloroform or methylene chloride), lower esters or polyols (for example, glyceol or glycols).

Suitable sweeteners or sweetening substances are natural di- and oligosaccharides such as sucrose, fructose, saccharose and the like. However, also artificial sweetener substitutes are suitable, either on their own or in combination with their natural representatives such as, for example:
Curculin: a protein fraction obtained from the plant Curculigo latifolia;
Miraculin: a glycoprotein isolated from Synsepalum dulcificum;
Osladine: a steroid saponin present in the rhizome of the Common polypody (Polypodium vulgare);
Perillartin: a chiralr racemic sweetener which represents the (E)-oxime of perilla aldehyde;
Steviosides and the aglycones thereof, such as, for example, rebaudioside A, B, C, D, E or dulcoside;
Mogrosides and the aglycones thereof which are, for example, obtained from the fruit of Luo Han Guo;
Dihydrochalcones such as, for example, neohesperidin dihydrochalcone or naringin dihydrochalcone.

In addition to the sugar substitutes mentioned above, naturally, also the classic sugar substitutes may be used such as, for example, saccharin, acesulfame, aspartame or superaspartame.

Suitable flavour enhancers are particularly glutamines.

The water-soluble constituents can be present in amounts of from about 6 to about 12 and, preferably, from about 8 to about 10% by weight.

d) Water-Insoluble Constituents and Dyes

In addition to the water-soluble extracts, the compositions may, eventually, also contain as component (d) water-insoluble constituents, which are selected from the group consisting of dietary fibres, pigments and dyes.

Dietary fibres mostly represent indigestible food particles, mostly polysaccharides, among which there are, particularly, carbohydrates of predominantly plant origin. In particular, the water-insoluble dietary fibres include the celluloses and hemicelluloses, specifically fibres as found in grains, fruit and vegetables and, particularly, in whole-grain products, barley and pulses.

The selection of dyes and pigments is based on whether they are food grade approved. Examples of yellow, red or orange dyes are:
E 100—Curcumin;
E 101—Riboflavin;
E 101a—Riboflavin-5-Phosphat;
E 102—Tartrazine;
E 104—Quinoline yellow;
E 110—Orange yellow S;
E 160 a—Carotene;
E 160 b—Annatto;
E 160 c—Paprika oleoresin;
E 160 d—Lycopene;
E 160 e—Beta-apo-8′-Carotenal;
E 160 f—Beta-apo-8′-Carotenal ethyl ester;
E 161 b—Lutein;
E 161 g—Canthaxanthin;
E 161 h—Zeaxanthin;
E 162—Betanin;
E 163—Anthocyanin;
E 180—Litho! Rubine BK;
E 120—Carmine;
E 122—Azorubine;
E 123—Amaranth (dye);
E 124—Cochineal Red A;
E 127—Erythrosine;
E 129—Allura Red AC

Examples of blue dyes are:
E 131—Patent blue V;
E 132—Indigo carmine;
E 133—Brilliant Blue FCF

Examples of green dyes are:
E 140—Chlorophyll;
E 141—Copper-containing compounds of chlorophylls and chlorophyllines;
E 142—Gree S

Examples of brown and black dyes are:
E 150a-d—Caramel colour;
E 151—Brilliant Black BN;
E 153—Activated carbon;
E 154—Brown FK;
E 155—Brown HT

Examples of white and metallic dyes are:
E 170—Calcium carbonate;
E 171—Titanium dioxide;
E 172—Ferric oxide pigments;
E 173—Aluminium;
E 174—Silver;
E 175—Gold.

The portion of these substances is typically from about 2 to about 10 and, preferably, about 5 to about 8% by weight.

e) Hydrocolloids and Emulsifiers

Finally, hydrocolloids may be present as component (e), which are—similarly to the polysaccharides, which form group (a2)—have a stabilizing effect and, therefore, overlap with them. Suitable examples are selected from the group consisting of gum arabic, pectins, galaktomannans, xanthan gum, guar gum, carob bean gum, gellan gum, modified starch and the mixtures thereof.

Among the hydrocolloids, gum arabic is preferred. Gum arabic comprises colourless to brown, matte, brittle, odourless pieces having a glossy fracture or powders which dissolve in warm water to give a clear, viscous, tacky, insipid-tasting and weakly acidic liquid. Gum arabic is substantially insoluble in alcohol. The substance consists mainly of the acidic alkaline earth metal and alkali metal salts of so-called arabic acid (polyarabic acid), which is understood as meaning a branched polysaccharide consisting of L-arabinose, D-galactose, L-rhamnose and D-glucuronic acid in the ratio 3:3:1:1.

Pectins are plant-based polysaccharides, which essentially consist of alpha-(1-4)-linked D-galacturonic acid units. From a nutrition physiology point of view, pectins represent dietary fibres for humans.

Galactomannans represent substances similar to starch which are composed of carbohydrate chains. The backbone consists of mannose, from which short side groups of galactose molecules branch off.

Xanthan gum is a natural thickener and gel former (E 415). It is obtained from sugar-containing substrates using bacteria of the genus Xanthomonas and is approved for use in organic foods.

Guar, or guar gum (E 412), essentially consists of the polysaccharide guaran. It is obtained by separating the outer layers and the seedling from the seed of the guar plant and subsequent milling.

Gellan gum also belongs to the polysaccharides. It has a linear structure and consists of a residue of rhamnose, one residue of glucoronic acid and two residues of glucose as monomer, which are esterified with acetic acid and glyceric acid. The molar mass amounts to approximately 500,000 Dalton.

N-osa starch is a particularly preferred suitable modified starch.

Particularly suitable emulsifiers are, besides Quillaja extracts, also the following substance categories:
Alkyl and/or alkenyl oligoglycosides, their production and use are known from the state of the art: They are produced, particularly, by reacting glucose or oligosaccharides with primary alcohols having 8 to 18 carbon atoms. So far as the glucoside residue is concerned, both monoglycosides, in which a cyclic sugar residue is glycosidically bound to the fatty alcohol, and also oligomer glycosides with a degree of oligomerization of, preferably, up to 8 are suitable. The degree of oligomerization is a statistical mean value based on the average distribution for these technical products.
Typical examples of suitable partial glycerides are hydroxystearic acid monoglyceride, hydroxystearic acid diglyceride, isostearic acid monoglyceride, isostearic acid diglyceride, oleic acid monoglyceride, oleic acid diglyceride, ricinoleic acid monoglyceride, ricinoleic acid diglyceride, linoleic acid monoglyceride, linoleic acid diglyceride, linolenic acid monoglyceride, linolenic acid diglyceride, erucic acid monoglyceride, erucic acid diglyceride, tartaric acid monoglyceride, tartaric acid diglyceride, citric acid monoglyceride, citric acid diglyceride, malic acid monoglyceride, malic acid diglyceride and technical mixtures thereof which may still contain small quantities of triglyceride from the production process. Addition products of 1 to 30 and preferably 5 to 10 moles of ethylene oxide onto the partial glycerides mentioned are also suitable.
Suitable sorbitan esters are sorbitan monoisostearate, sorbitan sesquiisostearate, sorbitan diisostearate, sorbitan triisostea rate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof. Addition products of 1 to 30 and preferably 5 to 10 mol ethylene oxide onto the sorbitan esters mentioned are also suitable. Instead of sorbitan, the esters may also be derived from glucose or mannose.
Typical examples of suitable polyglycerol esters are Polyglyceryl-2 Dipolyhydroxystearate (Dehymuls® PGPH), Polyglycerin-3-Diisostearate (Lameform® TGI), Polyglyceryl-4 Isostearate (Isolan® GI 34), Polyglyceryl-3 Oleate, Diisostearoyl Polyglyceryl-3 Diisostearate (Isolan® PDI), Polyglyceryl-3 Methylglucose Distearate (Tego Care® 450), Polyglyceryl-3 Beeswax (Cera)Bellina®, Polyglyceryl-4 Caprate (Polyglycerol Caprate T2010/90), Polyglyceryl-3 Cetyl Ether (Chimexane® NL), Polyglyceryl-3 Distearate (Cremophor® GS 32) and Polyglyceryl Polyricinoleate (Admul® WOL 1403), Polyglyceryl Dimerate Isostearate and mixtures thereof. Examples of other suitable polyolesters are the mono-, di- and triesters of trimethylolpropane or pentaerythritol with lauric acid, cocofatty acid, tallow fatty acid, palmitic acid, stearic acid, oleic acid, behenic acid and the like optionally reacted with 1 to 30 mol ethylene oxide.

The typically applied amount of hydrocolloids in this invention is from about 0.1 to about 4 and, preferably, from about 0.5 to about 2% by weight.

Process for the Production of the Liquid Aroma and Flavouring Compositions

Another subject matter of the present invention relates to a process for the production of liquid aroma and flavouring compositions, in which

(i) A first liquid aroma emulsion is produced by processing
(a) 0.1 to 40% by weight oil-soluble aromatic compounds,
(a2) 5 to 20% by weight stabilizers and
(a3) 0 to 1% by weight preservatives
in ad 100% by weight water applying strong shearing forces to obtain a homogeneous emulsion, and

(ii) (a) 10 to 25% by weight of the previously produced aroma emulsions or aroma concentrates,
(b) 5 to 20% by weight inorganic salts,
(c) 6 to 12% by weight water-soluble constituents,
(d) 2 to 10% by weight water-insoluble constituents and dyes, and
(e) 0.1 to 6% by weight hydrocolloids and emulsifiers
in ad 100% by weight water are processed applying strong shearing forces to obtain a homogeneous dispersion.

In a preferred form of embodiment the first aqueous aroma emulsion is produced by forming an aqueous phase containing the stabilizer and optionally further additives, for example, preservatives or acidifiers, dyes and the like, to which the oil-soluble aromatic compounds are then added. Both phases are subsequently homogenized applying strong shearing forces to the purpose of which, for example, an Ultra Turrax is particularly suitable. It is of course also possible to use other homogenization and dispersion processes known to the person skilled in the art.

The liquid aroma and flavouring compositions can be produced in a very similar manner, i.e. the aroma emulsions are added to the present aqueous phase including the salts, extracts and hydrocolloids, and then the composition is homogenized as described above. If desired, the products may subsequently be pasteurized or otherwise receive a thermal post-treatment. The products are emulsions or fine-particle dispersions and are storage-stable at room temperature for at least 6 weeks. This means that no separation or capture of solid substances worth mentioning takes place within this period. Viscosity is usually in the range of from about 1,000 to about 6,000 and preferably, from about 1,500 to about 4,000 mPas (RVT method, 20° C., 200 RPM, spindle 1).

Process for the Loading of Foods

Another subject matter of the invention relates to a process for the loading of foods with aroma and flavouring compositions where the liquid compositions according to the invention are sprayed on the foods. To this end, the liquid products manufactured as described above, which typically have a viscosity in the range of from about 1,000 to about 6,000 and, preferably, from about 1,500 to about 4,000 mPas (RVT method, 20° C., 200 RPM, spindle 1) are, for example, sprayed by means of a nozzle designed for two or more substances. As the liquid compositions are easily pumpable and sprayable, this aspect of use is uncritical. Suitable spray apparatus are any components the relevant person skilled in the art is notoriously familiar with for this purpose, i.e. a food technician with a professional experience of several years. Typically, the supply of the liquid products is carried out axially, whereby same are contacted with a tangential gas stream (air or an inert gas) in the mixing chamber of the nozzle. As a result of the interaction of gas and liquid, strong turbulences are created in the mixing chamber. The swirling liquid attempts to exit the nozzle, sloshing against the walls and the distributor plate and eventually flows through the nozzle discharge outlet such that the droplets are applied to the product in the form of an atomized spray cone as a consequence of the extreme shearing forces and, optionally, using an additional deflection ring. In doing so, the loading of the foods is controlled such that the final dosage is present in an amount of from about 2 to about 4% by weight based on the food obtaining a homogeneous spray pattern on the product surface.

### INDUSTRIAL APPLICATION

Another subject matter of the invention relates to foods loaded with the compositions according to the invention. Typical examples of suitable foods are biscuits, cereals, extruded foods such as, for example, pasta, and, more particularly, extrudates, for example, on the basis of maize or wheat, specifically, however, potato chips. These are typically loaded with about 2 to about 7% by weight of the compositions. In doing so, the dosage is about 30 to 40% lower than is usually the case; but the same sensory results are still achieved.

A last subject matter of the present invention relates to the use of the compositions according to the invention for loading foods.

### EXAMPLES

Example of Manufacture

a) Manufacturing the Pre-Emulsion

700 ml water were placed in an Ultraturrax with a capacity of 2.5 l and mixed with 15 g of oil-soluble aromatic compounds and 15 g gum arabic. Subsequently, the composition was homogenized over a period of 3 minutes.

b) Manufacturing the Aroma Emulsion

200 g of the pre-emulsion manufactured according to the above example, 250 g cooking salt, 100 g water-insoluble flavouring and herbal extracts, 50 g of dried spices and herbs and 20 g pectin were placed in a jet mixer from the company Ystral, dispersed in 380 g water and homogenized over a period of 30 minutes.

c) Applying the Aroma Emulsion to Foods

The aroma emulsion of example 1b) was subsequently applied to untreated potato chips by means of a Type 770 jet spray nozzle from the company Arcall/UK with two screw fittings with swirl slits. The spray cone angle of the nozzle was 70° and the quantity of applied material amounted to 4 g of aroma emulsion/100 g potato chips.

### Application Example 1

### Determining the Odour Intensity

By means of dynamic GC Headspace, 50 g each of the potato chips produced according to example H1 were compared to an analogous product, to which the same amount of aroma and flavouring substances was added according to the classic “dust on” method (i.e., by sprinkling). By means of the combined GC/MS method the amount of volatile aroma substances was determined in the head space above the sample. In doing so, it was found that the liquid aroma emulsions according to the invention had six times the concentration of aroma substances. This means that by applying the liquid aroma concentrates—in comparison to the conventional dust-on method—a far more intense odour is obtained. These effects were confirmed in sensory evaluations.

### Application Example 2

### Determining Saltiness

In a triangular test 41 test persons were asked to compare chips, which had been aromatised with sprinkled-on cooking salt, with other chips, onto which liquid aroma and flavouring composition in the context of the invention had been sprayed on; the NaCl concentrations were the same in both cases. The chips were served to the test persons size-reduced to prevent the salt from falling off and, therefore, avoid a distortion of the results. 39 of 41 test persons found that the chips tasted significantly different, 37 of them perceived the chips treated with the liquid aroma and flavouring composition to be clearly more salty despite of them having the same NaCl concentration. It follows vice versa that by means of liquid application the amount of cooking salt can be considerably reduced without significantly reducing the taste of salt.

1. Liquid aroma and flavouring compositions, comprising
(a) 10 to 25% by weight oil-soluble aroma emulsions or aroma concentrates,
(b) 15 to 25% by weight inorganic salts,
(c) 6 to 12% by weight water-soluble constituents,
(d) 2 to 10% by weight water-insoluble constituents and dyes,
(e) 0.1 to 6% by weight hydrocolloids and emulsifiers, and
(f) ad 100% by weight water,
with the proviso that the aroma emulsions forming component (a), which, in turn, comprise
(a1) 0.1 to 40% by weight oil-soluble aromatic compounds,
(a2) 5 to 20% by weight stabilizers,
(a3) 0 to 1% by weight preservatives and
(a4) ad 100% by weight water

2. Compositions according to claim 1, wherein the aroma emulsions, as component (a1), comprise oil-soluble aromatic compounds which are selected from the group consisting of essential oils of the group of aromatics and terpenes.

3. Compositions according to claim 1, wherein the aroma emulsions, as component (a2), comprise polysaccharides which are selected from the group consisting of gum arabic, pectin, xanthan gum, modified starch and the mixtures thereof.

4. Compositions according to claim 1, wherein they comprise, as component (b), inorganic salts which are selected from the group consisting of sodium chloride and potassium chloride and the mixtures thereof.

5. Compositions according to claim 1 4, wherein they comprise, as component (c), water-soluble constituents which are selected from the group consisting of plant and herb extracts, sweeteners and flavour enhancers.

6. Compositions according to claim 1, wherein characterized in that they comprise, as component (d), water-insoluble constituents which are selected from the group consisting of dietary fibres, pigments and dyes.

7. Compositions according to claim 1, wherein they comprise, as component (e), hydrocolloids which are selected from the group consisting of gum arabic, pectin, xanthan gum, galactomannans, guar gum, carob bean gum, gellan gum, CMC and the mixtures thereof.

8. A process for the production of liquid aroma and flavouring compositions, whereby
(i) a first aqueous aroma emulsion is produced by processing
(a1) 0.1 to 40% by weight oil-soluble aromatic compounds,
(a2) 5 to 20% by weight stabilizers and
(a3) 0 to 1% by weight preservatives
in ad 100% by weight water applying strong shearing forces to obtain a homogeneous emulsion, and
(ii) (a) 10 to 25% by weight of the aroma emulsions or aroma concentrates previously produced are processed
(b) 15 to 25% by weight inorganic salts,
(c) 6 to 12% by weight water-soluble constituents and dyes,
(d) 2 to 10% by weight water-insoluble constituents and
(e) 0.1 to 6% by weight hydrocolloids and emulsifiers
in ad 100% by weight water applying strong shearing forces to obtain a homogeneous dispersion.

9. A process according to claim 8, wherein the liquid aroma and flavouring compositions are subsequently pasteurized or otherwise thermally post-treated.

10. A process for loading foods with aroma and flavour compositions, in which the liquid compositions according to claim 1 are sprayed on the foods.

11. A process according to claim 10, wherein liquid compositions having a viscosity in the range of from 1,000 to 6,000 mPas (RVT method, 20° C., 200 rpm, spindle 1) are used.

12. Foods loaded with compositions according to claim 1.

13. Foods according to claim 12, wherein they include biscuits, pasta, potato chips or extrudates of potatoes, wheat or maize, optionally baked or fried.

14. Foods according to claim 12, wherein they are loaded with the compositions in amounts of from about 2 to 7% by weight.

15. Use of compositions according to claim 1 for loading of foods.

16. Compositions according to claim 2, wherein the aroma emulsions, as component (a2), comprise polysaccharides which are selected from the group consisting of gum arabic, pectin, xanthan gum, modified starch and the mixtures thereof.

17. Compositions according to claim 16, wherein they comprise, as component (b), inorganic salts which are selected from the group consisting of sodium chloride and potassium chloride and the mixtures thereof.

18. Compositions according to claim 3, wherein they comprise, as component (b), inorganic salts which are selected from the group consisting of sodium chloride and potassium chloride and the mixtures thereof.

19. Compositions according to claim 2, wherein they comprise, as component (b), inorganic salts which are selected from the group consisting of sodium chloride and potassium chloride and the mixtures thereof.

20. Compositions according to claim 17, wherein they comprise, as component (c), water-soluble constituents which are selected from the group consisting of plant and herb extracts, sweeteners and flavour enhancers.
